(19) United States
(12) Patent Application Publication
(10) Pub. No.: US 2007/0215847 A1
(43) Pub. Date: Sep. 20, 2007

(54) Flame Retardant Synthetic Fiber and Flame Retardant Textile Product Using the Same

(75) Inventors: Kouichi Nishiura, Hyogo (JP); Wataru Mio, Hyogo (JP); Toshiaki Ebisu, Hyogo (JP); Masanobu Tamura, Hyogo (JP); Masahiko Mihoichi, Hyogo (JP); Yoshitomo Matsumoto, Hyogo (JP); Shigeru Maruyama, Hyogo (JP)

Correspondence Address: BRINKS HOFER GILSON & LIONE, P.O. BOX 10395, CHICAGO, IL, 60610, US

(73) Assignee: KANEKA CORPORATION, OSAKA-SHI (JP)

(21) Appl. No.: 11/587,122

(22) PCT Filed: Apr. 25, 2005
(86) PCT No.: PCT/JP05/07818

§ 371 Date: Oct. 20, 2006

(30) Foreign Application Priority Data
Apr. 27, 2004 (JP) 2004-130874
Feb. 18, 2005 (JP) 2005-042096

(51) Int. Cl. C09K 21/00

(52) U.S. Cl. 252/601

(57) ABSTRACT

The present invention provides a flame retardant synthetic fiber, which is flame retardant by enhancing carbonization and shape retention in combustion by the use of an additive while retaining self-distinguishing property and which is favorably used for bedclothes and furniture necessary to have high flame retardancy, a flame retardant fiber composite containing the flame retardant synthetic fiber, and an upholstered furniture product using the flame retardant fiber composite. A flame retardant synthetic fiber obtained by spinning a composition containing 4 to 50 parts by weight of a glass component having a glass transition temperature of at most 400° C. based on 100 parts by weight of a polymer containing 17 to 70% by weight of a halogen atom. A flame retardant fiber composite comprising at least 10% by weight of (A) the flame retardant synthetic fiber and at most 90% by weight of (B) a natural fiber and/or a chemical fiber, and further an upholstered furniture product using the flame retardant fiber composite.

### TECHNICAL FIELD

The present invention relates to a flame retardant synthetic fiber having high flame retardancy which can be suitably used for textile products necessary to have high flame retardancy, for example, bedclothes such as a bed mattress and furniture such as a sofa by exhibiting extremely high carbonization property and self-extinguishing property in combustion, a flame retardant fiber composite obtained by conjugating the flame retardant synthetic fiber with other fibers, and a nonwoven fabric comprising the flame retardant fiber composite, and further relates to upholstered furniture products using the same.

### BACKGROUND ART

Recently, requirements for securing the safety of clothing, food and housing have been demanded, and necessity for flame retardant materials has been increasing from the viewpoint of flame proofness. Under such circumstances, necessity for imparting flame retardancy to materials used for bedclothes, furniture and the like is increasing in order to prevent fire which may occur during sleeping and cause a serious personal damage.

In these products such as bedclothes and furniture, easily-flammable materials such as cotton, polyester and urethane foam are often used in their interior or on their surface for obtaining amenity at use and design quality. It is important to provide high flame retardancy that prevents flaming to the easily-flammable materials over a long period of time by using suitable flame retardant materials in these products for securing flame proofness thereof. Further, the flame retardant materials must be those not damaging amenity and design quality of these products such as bedclothes and furniture.

Various flame retardant synthetic fibers and antiflaming agents have been studied for textile products used for the flame retardant materials, but those adequately satisfying such high flame retardancy as well as requirements such as the amenity and the design quality required for products such as bedclothes and furniture have not appeared yet.

For example, there is a procedure such as so-called post-processing flame proof in which an antiflaming agent is coated on a cotton cloth, but the procedure has problems such as uniformity of adhering the antiflaming agent, hardening of cloth due to adhesion, separation by cleaning, and safety.

Further, when polyester being an inexpensive material is used, since polyester cannot be a carbonized component, polyester is melted as forcibly burned to form holes, it cannot keep its structure, and cotton and urethane foam used for the above-described bedclothes, furniture and the like are flamed, thus, its performance was not adequate at all.

Further, although heat resistant nonflammable fiber is excellent in flame retardancy, it is extremely expensive, and the fiber has problems in processability at opening fibers and poorness in hygroscopic property and tactile impression. Further, it also has a problem that it is difficult to obtain colored design having high design quality because of poorness in dyeing property.

As materials having improved in the defects of flame retardant fiber materials used for these bedclothes and furniture and having excellent texture, hygroscopic property and tactile impression, which are required as general properties as well as having stable flame retardancy, there is proposed a flame retardant fiber composite in which a halogen-containing fiber to which a large amount of a flame retardant is added to provide high flame retardancy and other fibers that have no flame retardancy are combined (JP-A-61-89339), but the composite has problems that the addition of a large amount of the flame retardant is not advantageous in terms of costs and production processes, and there is a case where flame retardancy is insufficient as used for upholstered furniture products. Further, there are descriptions that a highly flame retardant fiber composite available for use in working wear is excellent in texture and hygroscopic property and has high flame retardancy by compounding a small amount of a heat resistant fiber (JP-A-8-218259), but an organic heat resistant fiber is generally colored so that whiteness of the fabric is inadequate, and there is also a problem in coloration by dyeing, thus, the composite was a flame retardant fiber composite having a problem in design quality. Further, a flame retardant nonwoven fabric having bulkiness by a substantially flame retardant fiber and a halogen-containing fiber is proposed for the mentioned materials (WO03/023108), but high flame retardancy is not obtained by these processes unless a plurality of fibers are combined, production steps of products become complicated, and there has been a problem that organic heat resistant fibers and substantially flame retardant fibers are generally expensive, thus, not advantageous in terms of costs. Further, although there is a flame retardant polyester material that is made flame retardant by a glass component, the cost is high because of a significantly large amount of the glass component, and the flame retardant polyester material has a problem regarding process stability at fiberizing; therefore, fiberization has not yet been reached (JP-A-9-278999).

### DISCLOSURE OF INVENTION

Problem to be Solved by the Invention

The present invention was made for solving problems that have been difficult to be solved by conventional flame retardant synthetic fibers, namely, for obtaining a flame retardant composite which has high flame retardancy, and is favorable in processability, texture and tactile impression and has design quality, and an upholstered furniture product using thereof.

Means to Solve the Problem

The present inventors have intensively studied means for solving the above-described problems, and as a result, have found that a flame retardant fiber which is excellent in processability, texture, tactile impression and dying property without damaging design quality, and exhibits extremely high carbonization and self-extinguishing property in combustion is obtained by containing in combination of a glass component having a low glass transition temperature and other inorganic additives in a halogen-containing synthetic fiber. Further, as a result of having found that the flame retardant fiber has high flame retardancy retaining the fiber shape after combustion as well, the present inventors found that a flame retardant fiber composite capable of obtaining textile products used for bedclothes, furniture and the like that are required to have high flame retardancy is obtained. Further, the present inventors found that improvements can be made in solving the problems with processability, design quality and prices caused when using a heat resistant fiber alone and have completed the present invention.

Namely, the present invention is a flame retardant synthetic fiber obtained by spinning a composition containing 4 to 50 parts by weight of a glass component having a glass transition temperature of at most 400° C. based on 100 parts by weight of a polymer containing 17 to 70% by weight of a halogen atom. Further, the flame retardant synthetic fiber is characterized in that the glass component has preferably a glass transition temperature of 200 to 400° C., and contains a phosphorous compound and/or a zinc compound, and the total amount of the glass component and other inorganic additive is 5 to 50 parts by weight based on 100 parts by weight of the polymer. Further, the present invention relates to a flame retardant fiber composite comprising at least 10% by weight of (A) the above-described flame retardant synthetic fiber and at most 90% by weight of (B) a natural fiber and/or a chemical fiber, wherein the fiber (B) preferably contains at most 40% by weight of a polyester fiber. Further, the present invention relates to an upholstered furniture product using this composite, a nonwoven fabric comprising the flame retardant fiber composite, in particular, a nonwoven fabric for flame shielding barrier and the upholstered furniture product using these.

### BEST MODE FOR CARRYING OUT THE INVENTION

A lower limit of a preferable halogen content in the polymer of the present invention containing 17 to 70% by weight of a halogen atom is 20% by weight, and 26% by weight. When the halogen content is less than 17%, it is not preferable since it is difficult to make fibers flame retardant and exhibit self-extinguishing property. An upper limit of the halogen content is a halogen content in a vinylidene bromide homopolymer, and the value is the upper limit value of the halogen content. In order to obtain more than this value of the halogen content, it is necessary to further increase a halogen atom in the monomer, which is not technologically practical.

Examples of the polymer containing 17 to 70% by weight of a halogen atom as described above are, for instance, a polymer of monomers containing a halogen atom, a copolymer of monomers containing a halogen atom and monomers without containing a halogen atom, a mixture of a polymer containing a halogen atom and a polymer without containing a halogen atom, and a halogen atom-containing polymer in which a halogen atom is introduced during or after polymerization of a monomer or a polymer without containing a halogen atom, but examples are not limited to these.

Specific examples of such polymer containing 17 to 70% by weight of a halogen atom are a homopolymer of a halogen-containing vinyl monomer or a vinylidene monomer such as vinyl chloride, vinylidene chloride, vinyl bromide, vinylidene bromide, vinyl fluoride and vinylidene fluoride or a copolymer of at least 2 of the monomers; a copolymer of acrylonitrile with a halogen-containing vinyl monomer or a vinylidene monomer such as acrylonitrile-vinyl chloride, acrylonitrile-vinylidene chloride, acrylonitrile-vinyl bromide, acrylonitrile-vinyl fluoride, acrylonitrile-vinyl chloride-vinylidene chloride, acrylonitrile-vinyl chloride-vinyl bromide, acrylonitrile-vinylidene chloride-vinyl bromide and acrylonitrile-vinylidene chloride-vinylidene fluoride; a copolymer of at least one of a halogen-containing vinyl monomer or a vinylidene monomer such as vinyl chloride, vinylidene chloride, vinyl bromide, vinylidene bromide, vinyl fluoride and vinylidene fluoride, acrylonitrile and a vinyl monomer copolymerizable with these; polymers. in which a halogen-containing compound is added and polymerized with an acrylonitrile homopolymer; halogen-containing polyesters; a copolymer of a vinyl alcohol and vinyl chloride; and a polymer in which polyethylene, polyvinyl chloride or the like is treated by addition of chlorine, but examples are not limited to these. Further, the homopolymers and copolymers may be used by being suitably mixed.

When the polymer containing 17 to 70% by weight of a halogen atom is a polymer comprising 30 to 70% by weight of acrylonitrile, 70 to 30% by weight of a halogen-containing vinyl monomer and/or a halogen-containing vinylidene monomer and 0 to 10% by weight of a vinyl monomer copolymerizable with these, and preferably a polymer comprising 40 to 60% by weight of acrylonitrile, 60 to 40% by weight of a halogen-containing vinyl monomer and/or a halogen-containing vinylidene monomer and 0 to 10% by weight of a vinyl monomer copolymerizable with these, it is preferable since an obtained fiber has texture of an acryl fiber while having desired performances (such as strength, flame retardancy and dyeing property).

Examples of the vinyl monomer copolymerizable with these are acrylic acid and esters thereof, methacrylic acid and esters thereof, acrylamide, methacrylamide, vinyl acetate, vinyl sulfonic acid and salts thereof, methallyl sulfonic acid and salts thereof, styrenesulfonic acid and salts thereof, and 2-acrylamide-2-methylsulfonic acid and salts thereof, and one or at least 2 of these are used. Further, when at least one among these is a vinyl monomer containing a sulfonic acid group, it is preferable since dyeing property is improved.

Specific examples of the copolymer containing units derived from a halogen-containing vinyl monomer and/or a halogen-containing vinylidene monomer and acrylonitrile are, for instance, a copolymer obtained by polymerizing 50 parts of vinyl chloride, 49 parts of acrylonitrile and 1 part of sodium styrenesulfonate, a copolymer obtained by polymerizing 47 parts of vinylidene chloride, 51.5 parts of acrylonitrile and 1.5 parts of sodium styrenesulfonate, and a copolymer obtained by polymerizing 41 parts of vinylidene chloride, 56 parts of acrylonitrile and 3 parts of sodium 2-acrylamide-2-methylsulfonate. These can be obtained by known polymerization methods such as emulsion polymerization, suspension polymerization and solution polymerization.

A glass component used for the present invention can be any one having a glass transition temperature of at most 400° C., and examples are SiO₂—PbO, SiO₂—PbO—ZnO, SiO₂—B₂O₃—Na₂O, SiO₂—B₂O₃—PbO, SiO₂—Al₂O₃, B₂O₃—PbO, B₂O₃—ZnO, B₂O₃—Na₂O—PbO, B₂O₃—PbO—ZnO, B₂O₃—P₂O₅, B₂O₃—Bi₂O₃—ZnO, P₂O₅—ZnO, hydrated phosphoric acid glass, boric acid glass, tellurite glass, and chalcogenide glass. Those containing a phosphorous compound and/or a zinc compound are preferable, but examples are not limited to these, and no adverse effect is caused if these are used in combination. Its amount in use is 4 to 50 parts by weight based on 100 parts by weight of the polymer containing 17 to 70% by weight of a halogen atom, preferably 7 to 40 parts by weight, and further more preferably 10 to 30 parts by weight. When the glass component is less than 4 parts by weight, an effect of retaining a shape of a carbonized layer is not obtained in combustion, and the desired flame retardancy is difficult to be acquired. When it exceeds 50 parts by weight, sufficient effects of retaining a shape are obtained, however, it is not preferable due to becoming factors of yarn breakage at fiberization in production steps and high costs. Further, a glass transition temperature of the glass component is at most 400° C., and preferably 200 to 300° C. When it is less than 200° C., the glass component rapidly melts in combustion, and it is considered that the desired effects of retaining the shape is easily obtained, but formation of the glass component tends to be difficult. When it exceeds 400° C., the glass component is not melted at a temperature at which the flame retardant synthetic fiber is decomposed in combustion; therefore, it is difficult to obtain the desired carbonization effects and the effects of retaining the shape. Further, an average particle diameter of the glass component is preferably at most 3 μm from the viewpoint of prevention of troubles such as nozzle plugging in the production steps of a fiber obtained by adding the glass component to the halogen-containing polymer, improvement in strength of a fiber, and dispersion of the glass component particles in the fiber. Further, no adverse effect is caused if chemical modification is carried out on the surface of glass component particles in order to improve blocking property.

In addition, it is more preferable to use 1 to 20 parts of a phosphoric ester compound in combination from the viewpoint of enabling carbides to be formed on a fiber surface in combustion. Nonlimiting examples of the phosphoric ester compound are compounds selected from triaryl phosphate, triphenyl phosphate, tri-n-butyl phosphate, tris(butoxyethyl)phosphate, cyclic phosphonic ester, bisphenol A-bis(diphenylphosphate) and the like.

Examples of the other inorganic additives used in the present invention are natural or synthetic mineral compounds such as kaoline, zeolite, montmorillonite, talc, bentonite and graphite, aluminum compounds such as aluminum hydroxide, aluminum sulfate and aluminum silicate, magnesium compounds such as magnesium hydroxide and magnesium oxide, and zinc compounds such as zinc oxide, zinc borate, zinc carbonate and zinc stannate, but examples are not limited to these. An amount thereof is 0 to 46 parts by weight based on 100 parts by weight of the polymer containing 17 to 70% by weight of a halogen atom, preferably 5 to 30 parts by weight, and more preferably 7 to 20 parts by weight. Even if it is 0 part by weight, the effects of retaining the shape due to the glass component is obtained, but it is preferable to add at least 5 parts by weight in order to obtain higher effects of retaining the shape. When the amount exceeds 46 parts by weight, the adequate effects of retaining the shape is obtained, but it is not preferable due to becoming a factor of yarn breakage at fiberization in the production steps.

The flame retardant synthetic fiber of the present invention may contain other additives such as an antistatic agent, a heat coloration preventing agent, a light resistance improving agent, a whiteness improving agent, a devitrification preventing agent and a coloring agent, if necessary.

The flame retardant synthetic fiber of the present invention is prepared by known preparation processes such as a wet spinning method, a dry spinning method, and a semi-dry-semi-wet method. For example, in the wet spinning method, the above-mentioned polymer is dissolved in solvents such as N,N-dimethylformamide, N,N-dimethylacetamide, acetone and an aqueous solution of rhodan salt, thereafter, it is coagulated by extruding the solution in a coagulation bath through a nozzle, and then the coagulated article is washed with water, dried, drawn, thermally treated, provided with crimp if necessary and cut to obtain a product. The flame retardant synthetic fiber of the present invention may be a staple fiber or a filament and can be suitably selected depending on its use method. For example, for processing by combining with other natural fibers and chemical fibers, a fiber similar to those to be combined is preferable, and a staple fiber with about 1.7 to 12 dtex and a cut length of about 38 to 128 mm is preferable for adjusting with other natural fibers and chemical fibers used for textile product uses.

The natural fiber and/or chemical fiber (B) used for the flame retardant fiber composite of the present invention is a component for providing excellent texture, tactile impression, design quality, product strength, washing resistance and durability to the textile product of the present invention, and for providing favorable processability at using a flame retardant nonwoven fabric for bedclothes and furniture.

Specific examples of the natural fiber are plant fibers such as cotton and hemp, and animal fibers such as wool, camel wool, goat wool and silk. Specific examples of the chemical fiber are regenerated fibers such as viscose rayon fiber and cupola fiber, semi-synthetic fibers such as acetate fiber, or synthetic fibers such as nylon fiber, polyester fiber, polyester binder fiber with a low melting point and acrylic fiber, but examples are not limited to these. These natural fibers and chemical fibers may be used alone together with the flame retardant synthetic fiber (A), or at least 2 kinds thereof may be used together with the flame retardant synthetic fiber (A).

The polyester fiber is preferable since a melted article is generated in combustion to cover a flame retardant nonwoven fabric, a carbonized layer formed by the flame retardant nonwoven fabric is further strengthened, performance of flame shielding barrier that prevents flaming to cotton and urethane foam used in bedclothes and furniture even if these are exposed to severe flame for a long period of time can be imparted, bulkiness as processed into the nonwoven fabric is easily obtained, and fiber breakage in an opening machine_(card) caused by the strength problem of the flame retardant synthetic fiber (A) is mitigated. However, when its amount exceeds 40 parts by weight in 100 parts by weight of the flame retardant fiber composite, it is not preferable since an area of a melted portion is enlarged, and adversely, the flame retardancy is lowered. When the polyester binder fiber with a low melting point is used, a concise thermal melt-adhesion method can be adopted at preparing a nonwoven fabric. The polyester binder fiber with a low melting point may be a polyester single type fiber with a low melting point, or also may be parallel type or core/sheath type composite fiber comprising polyester/polypropylene with a low melting point, polyethylene with a low melting point or polyester with a low melting point. In general, a melting point of the polyester with a low melting point is about 110 to 200° C., a melting point of the polypropylene with a low melting point is about 140 to 160° C., and a melting point of the polyethylene with a low melting point is about 95 to 130° C. The polyester binder fiber with a low melting point is not specifically limited so far as it is one generally having capability of melt-adhesion at about 110 to 200° C. Further, when a polyester fiber without having a low melting point is used, a convenient needle punch method can be adopted for preparing a nonwoven fabric.

In the present invention, the flame retardant fiber composite of the present invention is prepared from at least 10% by weight of (A) the flame retardant synthetic fiber and at most 90% by weight of (B) the natural fiber and/or chemical fiber, but their mixing ratio is determined in accordance with qualities such as water-absorbing property, texture, hygroscopic property, tactile impression, design quality, product strength, washing resistance and durability together with the flame retardancy required for a final product produced from the obtained flame retardant nonwoven fabric. In general, the flame retardant synthetic fiber (A) is 90 to 10% by weight, and preferably 60 to 20% by weight, the natural fiber and/or chemical fiber (B) is 10 to 90% by weight, and preferably 80 to 40% by weight, and these are conjugated so that their total amount is 100% by weight. When the thermal melt-adhesion method is selected for producing a nonwoven fabric, it is preferable to contain at least 10% by weight of the polyester binder fiber with a low melting point as the chemical fiber (B).

When an amount of the flame retardant synthetic fiber (A) of the present invention is less than 10 parts by weight, the desired high flame retardant is difficult obtain due to insufficient formation of a carbonized layer for preventing flaming to cotton and urethane foam used in bedclothes and furniture during being exposed to severe flame for a long period of time and also due to poor self-extinguishing property.

The flame retardant fiber composite of the present invention is a composite obtained by conjugating the fibers (A) and (B) as mentioned above, which is in the form of fabrics such as woven fabrics and knitted fabrics, and nonwoven fabrics, an aggregate of fibers such as sliver and web, yarns such as spun yarn, multiple-wound yarn and twisted yarn, and strings such as knitted strings and plaited strings.

Conjugating described above means that the fibers (A) and (B) are mixed by various methods to obtain fabrics and the like containing those fibers at a specified ratio, and means that the respective fibers and yarns are combined at steps of cotton mixing, spinning, twisting, weaving and knitting.

The flame retardant fiber composite of the present invention is suitably used as the nonwoven fabric for flame shielding barrier. The flame shielding barrier referred herein indicates shielding flame by carbonizing the flame retardant nonwoven fabric while keeping the shape of fibers when the flame retardant nonwoven fabric is exposed to flame to prevent flame from transferring to the opposite side. Specifically, flaming to interior structural articles such as urethane foam and packing cotton is prevented in the case of fire by sandwiching the flame retardant nonwoven fabric of the present invention between surface fabrics of a mattress, upholstered furniture or the like and urethane foam, packing cotton or the like to stop damage to a minimum. As a preparation process of the flame retardant nonwoven fabric, nonwoven fabric preparation processes such as a general thermal melt-adhesion method, a chemical bond method, a water jet method, a needle punch method and a stitch bond method can be used. After a plurality of kinds of fibers are mixed, they are opened by a card, a web is formed, and the flame retardant nonwoven fabric is prepared by applying the web to a nonwoven fabric manufacturing equipment. From the viewpoint of convenience of equipments, it is preferable to prepare by the needle punch method, and when using a polyester binder fiber with a low melting point, it is preferable to prepare by the thermal melt-adhesion method since these methods are general and the productivity is high, but the preparation processes are not limited thereto.

The flame retardant synthetic fiber of the present invention may contain an antistatic agent, a thermal coloration preventing agent, a light resistant improving agent, a whiteness improving agent, a devitrification preventing agent and the like, if necessary, and no problem is caused if coloration or dyeing by dyes, pigments, etc, is carried out.

The flame retardant fiber composite of the present invention obtained in this manner has desired flame retardancy and is excellent in properties such as texture, tactile impression, hygroscopic property and design quality.

The upholstered furniture product mentioned in the present invention indicates bedclothes such as mattress, chairs, sofas, automobile seats and the like.

Examples of the mattress are mattresses such as a pocket coil mattress and a box coil mattress in which coils made of metal are used inside, or a mattress in which an insulator obtained by foaming styrene, urethane resin, etc. is used inside. Since flame proofness by the flame retardant fiber composite used in the present invention is exerted, flame propagation to the structure of the mattress interior can be prevented; therefore, a mattress excellent in texture and tactile impression as well as flame retardancy can be obtained in mattresses with any structure.

On the other hand, examples of the chair are those used indoors such as a stool, a bench, a side chair, an arm chair, a lounge chair and a sofa, a seat unit (such as a sectional chair and a separate chair), a rocking chair, a folding chair, a stacking chair and a swivel chair, or those used outdoors for vehicle chairs such as automobile seats, seats for a ship, seats for an aircraft and seats for a train, and for these, upholstered products having a function of preventing flame propagation to the interior as well as appearance and tactile impression, required as general furniture can be obtained.

As usages of the flame retardant fiber composite of the present invention for upholstered furniture products, the composite may be used for surface textile in the form of woven fabric or knit, or may be sandwiched between a surface textile and interior structures, for example, urethane foam or filling cotton in the form of woven fabric, knit or nonwoven fabric. When used as the surface textile, a fabric comprising the flame retardant fiber composite of the present invention may be used in place of conventional surface textiles. Further, when the woven fabric or knit is sandwiched between the surface textile and the interior structure, it may be sandwiched in such a manner as laminating 2 pieces of the surface textiles, or the interior structure may be covered by the woven fabric or knit comprising the flame retardant fiber composite of the present invention. When the flame retardant fiber composite is sandwiched between the surface textile and the interior structure as a nonwoven fabric for flame shielding barrier, a nonwoven fabric comprising the flame retardant fiber composite of the present invention is covered on the whole of the interior structure or at least on the outside of a portion of the interior structure in contact with the surface textile without fail, and the surface textile is stretched over it.

When upholstered furniture is produced using the flame retardant fiber composite of the present invention, there is obtained an upholstered furniture product having excellent properties that the flame retardant fiber composite of the present invention has, namely, having excellent flame retardancy and excellent properties such as texture, tactile impression, hygroscopic property and design quality.

The reason why the flame retardant synthetic fiber and the flame retardant fiber composite of the present invention show highly excellent flame retardancy is considered as follows. When the flame retardant fiber composite comprising the flame retardant synthetic fiber (A) containing the total amount of 5 to 50 parts by weight of a glass component having a glass transition temperature of at most 400° C. and other inorganic additive based on 100 parts by weight of a polymer containing 17 to 70% by weight of a halogen atom and the natural fiber and/or chemical fiber (B) is burned by other flaming sources, a nonflammable gas containing a halogen atom, for example, chlorine gas or hydrochloric acid gas is generated from the flame retardant synthetic fiber (A), and a glass component contained in the flame retardant synthetic fiber (A) is melted, thereby, surface diffusion of an easily-flammable gas from the inside of fibers is suppressed to prevent from burning (self-extinguishing property); therefore, the flame retardant fiber composite becomes a carbonized product without burning destruction and loss. Further, the melted glass component enters into the carbonized product generated by combustion of the flame retardant synthetic fiber (A) or the natural fiber and/or chemical fiber (B), and other inorganic additive contained in the flame retardant synthetic fiber (A) and is solidified to form a rigid carbonized layer (carbonization effects and shape retaining effects). As a result of these, since the flame retardant fiber composite retains the shape in the state of carbonized products without collapsing after combustion, highly excellent flame retardancy is shown by shielding flame and suppressing further flame propagation.

### EXAMPLES

The present invention is explained further in detail based on Examples in the following, but the present invention is not limited only thereto. Flame retardancy of fibers in Examples was evaluated by evaluation methods 1 and 2 shown below using nonwoven fabrics in addition to a method using LOI values. The evaluation method 1 is a simple evaluation method mainly for flame retardant synthetic fibers alone and the evaluation method 2 is a simple evaluation method for real upholstered furniture etc such as a mattress, a chair and a sofa, by which the presence of ignition to the interior structure in case of fire can be judged by sandwiching the flame retardant nonwoven fabric of the present invention between the surface textile and the interior structure such as urethane foam or filling cotton.

(Evaluation Method 1 of Flame Retardancy with Nonwoven Fabric)

(1) Preparation of Nonwoven Fabric for Flame Retardancy Evaluation Test

After a fiber was opened by a roller card, a nonwoven fabric having a weight per unit area of 200 g/m² and a size of 20 cm long×20 cm broad was prepared by a needle punch method.

(2) Flame Retardancy Evaluation Test Method

A perlite board with a size of 200 mm long×200 mm broad×10 mm thick having a hole with 15 cm diameter on the center of the board was prepared, a nonwoven fabric for the evaluation test of flame retardancy was placed thereon, and 4 sides thereof were fixed with clips so that the nonwoven fabric for the flame retardancy evaluation test was not shrunk during heating. This sample was set above a gas burner (PA-10H-2 manufactured by Paloma, Ltd.) 40 mm apart from the burner top while setting the face of the nonwoven fabric for the flame retardancy evaluation test upward, so that the center of the sample was matched with the center of the burner. Propane with purity of at least 99% was used as fuel gas, a height of flame was set at 25 mm and a combustion time was set for 180 seconds. At this time, evaluation was carried out, referring to a case where there is no thickness plaque of a carbonized layer in the nonwoven fabric for the flame retardancy evaluation test and no hole and crack were observed as ⊚, a case where there is no penetrated hole on the carbonized layer or no crack as ◯, and a case where there are holes and cracks as ×.

(Flame Retardancy Evaluation Method 2 with Nonwoven Fabric)

(1) Preparation of a Sample for Flame Retardancy Evaluation Test

After a fiber mixed at a fixed proportion was opened by a roller card, a nonwoven fabric having a weight per unit area of 210 g/m² and a size of 45 cm long×30 cm broad was prepared by a thermal melt-adhesion method. Urethane foam (45 cm long×30 cm broad and 53 mm thick) was piled under the nonwoven fabric, a nonwoven fabric made of polyester with the same size (a weight per unit area of 300 g/m²) and further, a fabric made of polyester (a weight per unit area of 120 g/m²) were piled on the nonwoven fabric, and these 4 fabrics were fixed with staplers (Hotchkiss: trade mark) so as to prepare a sample for the flame retardancy evaluation test.

(2) Flame Retardancy Evaluation Test Method

Flame retardancy evaluation test was carried out in accordance with the test method of a bed mattress upper face among burning test methods of a bed mattress: Technical Bulletin 603 (hereinafter, referred to as TB603) of California, USA. Namely, a T-shaped burner was horizontally set at 39 mm from the upper surface of the sample for the flame retardancy evaluation test, propane gas was used as fuel gas, and flame was contacted for 70 seconds under the conditions of a gas pressure at 101 KPa and a gas flow rate at 12.9 L/min. At this time, evaluation was carried out, referring to a case where there is no thickness plaque of a carbonized layer in the nonwoven fabric for the flame retardancy evaluation test and no hole and crack were observed as ⊚, a case where there is no penetrated hole on the carbonized layer or no crack as ◯, and a case where there are holes and cracks and urethane foam in the bottom part is flamed as Δ. ⊚and ◯are accepted.

(Flame Retardancy Evaluation with LOI Value)

2 g of fibers prepared in accordance with the following production example was sampled, this sample was equally divided into 8 pieces to prepare 8 fiber twists of about 6 cm, the fiber twists were vertically erected on a holder of an oxygen index measuring device, the minimum oxygen concentration necessary for burning the sample by 5 cm was measured, and this value was referred to as a LOI value. The larger the LOI value is, the more hardly the sample burns and the higher the flame retardancy is.

(Measurement Method of Halogen Content in Fibers)

The elemental analysis with respect to C element, H element and N element was carried out on the obtained copolymer by YANACO CHN Coder MT-5 manufactured by Yanagimoto Mfg. Co., Ltd., N atom was assumed to be derived from acrylonitrile, and the content of acrylonitrile component in the polymer was determined by the content of N atom. Further, assuming that the whole amount of sodium p-styrenesulfonate was copolymerized, the residue was to be a component derived from a halogen monomer, and the halogen content in the obtained halogen-containing copolymer was determined by calculation.

(Evaluation of Fiberization)

In a fiberization evaluation, it is referred to as x when trial fibers cannot be prepared, such as a case where clogging at a nozzle occurs or fibers can not be drawn. Regarding the evaluation method of spinning property and drawing property, if it is possible to draw by at least 3-fold, it was judged as favorable. If it is possible to draw by at least 2-fold, but a thread is broken unless the drawing is less than 3-fold, it is judged as medium. If it is impossible to draw by at least 2-fold, it is judged as bad. If drawing is impossible or it is impossible to prepare the trial fiber, it was judged as disapproval.

### Preparation Example

A copolymer (halogen content: 35% by weight) obtained by polymerizing 51% of acrylonitrile, 48% of vinylidene chloride and 1% of sodium p-styrenesulfonate was dissolved in dimethylformamide so that a resin concentration was 30%, thereto were added a specified glass component and aluminum hydroxide as an inorganic additive in the addition amounts shown in Table 1 based on the resin amount in the obtained resin solution to prepare a spinning concentrate solution. The spinning concentrate solution containing the glass component and aluminum hydroxide was extruded in a 50% dimethylformamide aqueous solution using a nozzle with a nozzle hole diameter of 0.10 mm having the number of 1000 holes, the extruded article was rinsed with water and then dried at 120° C., subsequently it was drawn by 3-fold, then, further thermally treated at 150° C. for 5 minutes and cut to obtain a flame retardant synthetic fiber. The obtained fiber was a staple fiber having fineness of 5.6 dtex and a cut length of 51 mm.

### Example 1

A copolymer obtained by polymerizing 51.5 parts by weight of acrylonitrile, 47.3 parts by weight of vinylidene chloride and 1.2 parts by weight of sodium styrenesulfonate was dissolved in acetone so that a resin concentration was 30% by weight. To the obtained resin solution, a B₂O₃—ZnO—PbO glass compound (equivalent to a glass transition temperature of 320° C., available from Asahi Glass Co., Ltd.) was added as a glass component having a melting point of at most 600° C. so as to be 20 parts by weight based on 100 parts by weight of the copolymer to prepare a spinning concentrate solution. The spinning concentrate solution was extruded in 35% acetone aqueous solution at 25° C. using a nozzle having a hole diameter of 0.08 mm and the number of 500 holes, the extruded article was pulled up at 3.0 m/min, rinsed with water and then dried at 130° C. for 8 minutes, subsequently, it was stretched by 2.5-fold at 130° C., then thermally treated at 160° C. for 5 minutes, thereby a flame retardant synthetic fiber with a single fiber fineness of 2.2 dtex was obtained. The LOI value measured of the obtained fiber was 39.

### Example 2

A copolymer obtained by polymerizing 49.0 parts by weight of acrylonitrile, 50.5 parts by weight of vinyl chloride and 0.5 part by weight of sodium styrenesulfonate was dissolved in acetone so that a resin concentration was 30% by weight. To the obtained resin solution, the B₂O₃—ZnO—PbO glass compound described in Example 1 was added so as to be 20 parts by weight based on 100 parts by weight of the copolymer to prepare a spinning concentrate solution. The spinning concentrate solution was extruded in 35% acetone aqueous solution at 25° C. using a nozzle having a hole diameter of 0.08 mm and the number of 500 holes, the extruded article was pulled up at 3.0 m/min, rinsed with water and then dried at 120° C. for 8 minutes, subsequently, it was stretched by 2.5-fold at 120° C., then thermally treated at 145° C. for 5 minutes, thereby, a flame retardant synthetic fiber having a single fiber fineness of 2.2 dtex was obtained. The LOI value measured of the obtained fiber was 36.

### Example 3

A preparation of a flame retardant synthetic fiber was carried out in the same manner as in Example 1 except that an amount of the B₂O₃—ZnO—PbO glass compound described in Example 1 was 40 parts by weight and a draw ratio was 1.5 times. The LOI value measured of the obtained fiber was 48.

### Example 4

A preparation of a flame retardant synthetic fiber was carried out in the same manner as in Example 1 except that an amount of the B₂O₃—ZnO—PbO glass compound described in Example 1 was 5 parts by weight. It was possible to draw at least 3-fold. The LOI value measured of the obtained fiber was 32.

### Example 5

A preparation of a flame retardant synthetic fiber was carried out in the same manner as in Example 1 except that an amount of ZP-150 (a glass transition temperature of 360° C.) containing a phosphoric acid compound and zinc oxide as main components and available from Asahi Fiber Glass Co., Ltd. as the glass component described in Example 1 was 20 parts by weight. The LOI value measured of the obtained fiber was 45.

### Example 6

A preparation of a flame retardant synthetic fiber was carried out in the same manner as in Example 5 except that VIGOL GPE-515 available from Daikyo Chemical Co., Ltd. was used as a phosphoric ester in addition to the glass component ZP-150 described in Example 5 and its amount was 15 parts by weight. The LOI value measured of the obtained fiber was 47.

### Comparative Example 1

A preparation of a flame retardant synthetic fiber was carried out in the same manner as in Example 1 except that an amount of the B₂O₃—ZnO—PbO glass compound described in Example 1 was 70 parts by weight, however, spinning property was significantly poor at producing fibers and drawing was totally impossible; thus, fibers could not be produced.

### Comparative Example 2

A preparation of a flame retardant synthetic fiber was carried out in the same manner as in Example 1 except that an amount of the B₂O₃—ZnO—PbO glass compound described in Example 1 was 3 parts by weight. It was possible to draw by at least 3-fold. The LOI value measured of the obtained fiber was 29. This is a low value in comparison with Examples and Reference Example (conventional products).

### Comparative Example 3

A preparation of a flame retardant synthetic fiber was carried out in the same manner as in Example 1 except that a compound containing the glass component having a glass transition temperature of at most 400° C. described in Example 1 was not contained. It was possible to draw by at least 3-fold. The LOI value measured of the obtained fiber was 28. The value is low in comparison with Examples and Reference Example (conventional products).

### Reference Example

A preparation of a flame retardant synthetic fiber was carried out in the same manner as in Example 1 except that antimony trioxide was used in place of the compound containing the glass component having a glass transition temperature of at most 400° C. described in Example 1. The LOI value measured of the obtained fiber was 30.

Results of Examples and Comparative Examples are shown in Table 1.

TABLE 1

| | Amounts of a compound containing | | Spinning |
|---|---|---|---|
| | a glass component having a glass | | property and |
| | transition temperature of at | LOI | drawing |
| | most 400° C. | value | property |
| Ex. | | | |
| 1 | 20% by weight | 39 | ◯ |
| 2 | 20% by weight | 36 | ◯ |
| 3 | 40% by weight | 48 | Δ |
| 4 | 5% by weight | 32 | ⊚ |
| 5 | 20% by weight | 45 | ◯ |
| 6 | 20% by weight | 47 | Δ |
| | (phosphoric ester 15% by weight) | | |
| Com. Ex. | | | |
| 1 | 70% by weight | — | X |
| 2 | 3% by weight | 29 | ⊚ |
| 3 | None | 28 | ⊚ |
| Ref. Ex. | 20% by weight (Sb203) | 30 | ◯ |

Evaluation of spinning property and drawing property
⊚: favorable,
◯: ordinary,
Δ: bad,
X: impossible to prepare fibers

### Examples 7 to 11 and Comparative Examples 4 to 6

According to the Preparation Example, flame retardant synthetic fibers in which a glass component (P₂O₅—ZnO glass, a glass transition temperature of 240° C., ZP450 available from Asahi Fiber Glass Co., Ltd.) and aluminum hydroxide were added in amounts in Table 2 were prepared, and the flame retardancy evaluation by the evaluation method 1 with nonwoven fabrics and LOI values were carried out. Results are shown in Table 2. A mixture of 80 parts by weight of the fiber of the present invention and 20 parts by weight of a polyester fiber (available from TOYOBO Co., Ltd., 6.6 dtex, a cut length of 51 mm) was used as the nonwoven fabric.

The test results of flame retardancy in Examples 1 to 5 were favorable, the nonwoven fabrics for the flame retardancy evaluation test formed a favorable carbonized layer after heating by a gas burner, generation of remaining flame, cracks and perforations was not caused, and the general judgment was approved. To the contrary, an amount of aluminum hydroxide in Comparative Example 4 was the same as that in Examples 7 to 10, but the amount of a glass component was small, thus, a favorable carbonized layer could not be formed, holes were generated on the nonwoven fabrics, and the general judgment was not approved. Since the amount of the glass component in Comparative Example 5 and the amount of aluminum hydroxide in Comparative Example 6 were respectively large, fibers were not able to be formed.

TABLE 2
Test results of flame retardancy evaluation of Examples
7 to 11 and Comparative Examples 4 to 6

| | Additives in flame retardant | | | | | | |
|---|---|---|---|---|---|---|---|
| | synthetic fiber | | | | | | |
| | Glass | Aluminum | | | Flame retardancy | | |
| | component | hydroxide | Total amount | | evaluation results | | |
| | Added | Added | of additives | Fiberization | | Evaluation | |
| | amount (part | amount (part | (part by | evaluation | LOI | method 1 | General |
| | by weight) | by weight) | weight) | results | value | Results | evaluation |
| Ex. | | | | | | | |
| 7 | 10 | 10 | 20 | ◯ | 36.2 | ◯ | ◯ |
| 8 | 20 | 10 | 30 | ◯ | 39.3 | ⊚ | ◯ |
| 9 | 25 | 10 | 35 | ◯ | 37.2 | ⊚ | ◯ |
| 10 | 30 | 10 | 40 | ◯ | 37.7 | ⊚ | ◯ |
| 11 | 40 | 0 | 40 | ◯ | 37.5 | ⊚ | ◯ |
| Com. | | | | | | | |
| Ex. | | | | | | | |
| 4 | 3 | 10 | 13 | ◯ | 36.0 | X | X |
| 5 | 55 | 10 | 65 | X | unfeasible | unfeasible | unfeasible |
| 6 | 10 | 50 | 60 | X | unfeasible | unfeasible | unfeasible |

### Examples 12 to 14 and Comparative Example 7

According to the Preparation Example, flame retardant synthetic fibers in which glass components (P₂O₅—ZnO glass, ZP450 available from Asahi Fiber Glass Co., Ltd., a glass transition temperature of 240° C. (EXAMPLE 12), 260° C. (EXAMPLE 13), 350° C. (EXAMPLE 14), 420° C. (COMPARATIVE EXAMPLE 7) having different glass transition temperatures and aluminum hydroxide were added in amounts in Table 3 were prepared, and the flame retardancy evaluation by the evaluation method 1 with a nonwoven fabric and the LOI value were carried out. Results are shown in Table 3. Further, as the nonwoven fabric, those produced by mixing 80 parts by weight of the fiber of the present invention and 20 parts by weight of a polyester fiber (available from TOYOBO Co., Ltd., 6.6 dtex, a cut length of 51 mm) was used.

The test results of flame retardancy in Examples 12 to 14 were favorable, the nonwoven fabrics for the flame retardancy evaluation test formed a favorable carbonized layer after heating by a gas burner, generation of remaining flame, cracks and perforations was not caused, and the general judgment was approved. To the contrary, in Comparative Example 7, as a result that a glass transition temperature was high, and flame retardation insufficiently functioned, a favorable carbonized layer was not formed, holes were generated on the nonwoven fabrics, and the general judgment was not approved.

TABLE 3
Test results of flame retardancy evaluation of
Examples 12 to 14 and Comparative Example 7

| | Additives in flame retardant synthetic fiber | | | | | | |
|---|---|---|---|---|---|---|---|
| | Glass | | | | | | |
| | component | | Aluminum | | Flame retardancy | | |
| | Glass | Added | hydroxide | Total amount | evaluation results | | |
| | transition | amount | Added | of additives | | Evaluation | |
| | temperature | (part by | amount (part | (part by | LOI | method 1 | General |
| | (° C.) | weight) | by weight) | weight) | value | Results | evaluation |
| Ex. | | | | | | | |
| 12 | 240 | 40 | 0 | 40 | 37.5 | ⊚ | ◯ |
| 13 | 260 | 40 | 0 | 40 | 36.5 | ⊚ | ◯ |
| 14 | 350 | 40 | 0 | 40 | 37.0 | ◯ | ◯ |
| Com. | | | | | | | |
| Ex. | | | | | | | |
| 7 | 420 | 40 | 0 | 40 | 37.0 | X | X |

### Examples 15 to 20 and Comparative Examples 8 to 10

According to the Production Example, flame retardant synthetic fibers in which a glass component (P₂O₅—ZnO glass, a glass transition temperature of 240° C.) and aluminum hydroxide were added in amounts in Table 4 were prepared, and nonwoven fabrics containing the obtained flame retardant synthetic fiber, a polyester fiber (6.6 dtex, a cut length of 51 mm), a rayon fiber (1.5 dtex, a cut length of 38 mm) and a cotton fiber at specified ratios were prepared, and the flame retardancy evaluation by the evaluation method 2 with a nonwoven fabric was carried out. Results are shown in Table 4.

The test results of flame retardancy in Examples 15 to 20 were favorable, cracks and holes even after heating were not generated on the nonwoven fabrics for the flame retardancy evaluation test, and a favorable carbonized layer was formed. To the contrary, since the mixing ratio of the flame retardant synthetic fiber was low in Comparative Example 8, a favorable carbonized layer was not formed, holes were generated on the nonwoven fabrics, and the general judgment was not approved. Since the mixing ratio of a polyester fiber was high in Comparative Example 9, a portion of the polyester fiber was melted, holes were generated, and the general judgment was not approved. Since the amount of the glass component in the flame retardant synthetic fiber was low in Comparative Example 10, a favorable carbonized layer could not be formed, holes were generated on the nonwoven fabric, which was not approved.

TABLE 4
Test results of flame retardancy evaluation of Examples
15 to 20 and Comparative Examples 8 to 10

| | | | | | | | | Flame |
|---|---|---|---|---|---|---|---|---|
| | Added amount in flame | | | Fiber ratio composing nonwoven fabric | | | | retardancy |
| | retardant synthetic fiber | | | (part by weight) | | | | evaluation |
| | (part by weight) | | | Flame | | | | results |
| | | | Total | retardant | | | | Evaluation |
| | Glass | Aluminum | amount of | synthetic | Rayon | Cotton | Polyester | method 2 |
| | component | hydroxide | additives | fiber | fiber | fiber | fiber | Results |
| Ex. | | | | | | | | |
| 15 | 20 | 10 | 30 | 80 | 0 | 0 | 20 | ◯ |
| 16 | 20 | 10 | 30 | 40 | 40 | 0 | 20 | ⊚ |
| 17 | 20 | 10 | 30 | 30 | 50 | 0 | 20 | ⊚ |
| 18 | 20 | 10 | 30 | 20 | 60 | 0 | 20 | ◯ |
| 19 | 30 | 10 | 40 | 80 | 0 | 0 | 20 | ◯ |
| 20 | 30 | 10 | 40 | 30 | 0 | 50 | 20 | ⊚ |
| Com. | | | | | | | | |
| Ex. | | | | | | | | |
| 8 | 20 | 10 | 30 | 5 | 75 | 0 | 20 | X |
| 9 | 20 | 10 | 30 | 30 | 20 | 0 | 50 | X |
| 10 | 3 | 10 | 13 | 40 | 40 | 0 | 20 | X |

### INDUSTRIAL APPLICABILITY

An interior textile products using the flame retardant synthetic fiber, flame retardant fiber composite and nonwoven fabric of the present invention are excellent in texture, tactile impression, designing quality such as visual impression, and processability, and can have high flame retardancy durable to flame for a long period of time and self-extinguishing property.

1. A flame retardant synthetic fiber obtained by spinning a composition comprising 4 to 50 parts by weight of a compound containing a glass component having a glass transition temperature of at most 400° C. based on 100 parts by weight of a polymer containing 17 to 70% by weight of a halogen atom.

2. The flame retardant synthetic fiber of claim 1, wherein said polymer containing halogen comprises 30 to 70 parts by weight of acrylonitrile, 70 to 30 parts by weight of a vinyl monomer containing halogen and/or a vinylidene monomer containing halogen, and 0 to 10 parts by weight of a vinyl monomer copolymerizable therewith.

3. The flame retardant synthetic fiber of claim 1, wherein said glass component has a glass transition temperature of 200 to 400° C.

4. The flame retardant synthetic fiber of any one of claim 3, wherein said glass component comprises a phosphorous compound and/or a zinc compound.

5. The flame retardant synthetic fiber of any one of claim 1, comprising a compound containing the glass component having a glass transition temperature of at most 400° C. and a phosphoric ester compound.

6. The flame retardant synthetic fiber of any one of claim 1, wherein the total amount of the glass component and other inorganic additive is 5 to 50 parts by weight based on 100 parts by weight of the polymer.

7. The flame retardant synthetic fiber of claim 6, wherein the other inorganic additive is natural or synthetic mineral compounds such as kaoline, zeolite, montmorillonite, talc, bentonite and graphite, aluminum compounds such as aluminum hydroxide, aluminum sulfate and aluminum silicate, magnesium compounds such as magnesium hydroxide and magnesium oxide, and zinc compounds such as zinc oxide, zinc borate, zinc carbonate and zinc stannate.

8. A textile product using the flame retardant synthetic fiber of any one of claim 6.

9. A flame retardant fiber composite, comprising at least 10% by weight of (A) the flame retardant synthetic fiber of any one of claim 6, and at most 90% by weight of (B) a natural fiber and/or a chemical fiber.

10. The flame retardant fiber composite, wherein the fiber (B) of claim 9 is a polyester fiber and the polyester fiber is contained in an amount of at most 40% by weight.

11. The flame retardant fiber composite of claim 10, wherein the polyester fiber is a binder fiber having a low melting point.

12. A nonwoven fabric comprising the flame retardant fiber composite of any one of claim 1.

13. An upholstered furniture product using the nonwoven fabric of claim 12.
